(19) United States
(12) Patent Application Publication
(10) Pub. No.: US 2011/0010473 A1
(43) Pub. Date: Jan. 13, 2011

(54) Computer Monitor With Integral KVM Switch

(76) Inventor: Thomas H. Szolyga, Saratoga, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/921,188

(22) PCT Filed: Mar. 8, 2008
(86) PCT No.: PCT/US08/56336

§ 371 Date: Sep. 7, 2010

(51) Int. Cl. G06F 13/10

(52) U.S. Cl. 710/36

(57) ABSTRACT

A computer monitor incorporates a KVM switch.

### BACKGROUND OF THE INVENTION

Computers have become so prevalent that many users have more than one computer. It is not atypical for users to have 1) separate computers for home and for work, 3) a laptop and a desktop, 3) one computer with secure files and a separate one for accessing the Internet, or 4) one computer for rendering video and graphics, and another for use during rendering. However, it is not always necessary for each computer to have a full-complement of dedicated peripherals. Many peripherals, such as printers, network storage devices, and broadband modems can be shared over a network.

Not all peripherals are networkable. For example, computer monitors, mice, and keyboards are typically not networkable. Also, some printers or scanners are not network-able. Even peripherals that are networkable, are not always set up to work on a network. For these situations, non-network approaches to peripheral sharing are available.

Some peripherals have multiple connection ports. In some cases, the multiple ports are primarily intended to allow multiple computers to connect. In other cases, the primary purpose for the multiple connections is to accommodate different connection standards. For example, printers may include a parallel port and a USB port; monitors may include an analog video port and a digital video port. In such cases, the multiple ports may make it convenient to switch control of the peripheral from one computer to another. However, each peripheral with multiple ports must be switched separately, and not all peripherals permit switching among ports.

Switches are available for making peripherals available to more than one computer. KVM (Keyboard, Video, Mouse) switches in particular allow two (or more) computers to share a keyboard, a video monitor, and a mouse. A KVM switch effectively switches the human interface from one computer to another. Variants of the KVM switch also allow speakers and other devices (e.g., USB devices) to be shared among computers. A disadvantage of the KVM switch is that it is an additional device taking its place among an already complex system with multiple computers and multiple peripherals. What is needed is a more elegant solution for sharing peripherals among multiple computers.

Herein, related art is described to facilitate understanding of the invention. Related art labeled “prior art” is admitted prior art; related art not labeled “prior art” is not admitted prior art.

### BRIEF DESCRIPTION OF THE DRAWINGS

The figures depict implementations/embodiments of the invention and not the invention itself.

FIG. 1 is a schematic diagram of a computer system with a monitor incorporating a KVM switch in accordance with an embodiment of the invention. In FIG. 1, dotted lines carry mouse signals, dot-dash lines carry keyboard signals, and double-dot-dash lines carry video signals. The dots and dashes are connected along active signal paths and unconnected along inactive signal paths.

FIG. 2 is a schematic diagram of a computer system in accordance with another embodiment of the invention. This embodiment incorporates a USB hub along with a KVM switch. USB connections are indicated in dash, with connected dashes indicating an active USB connection. In FIG. 2, the double-dot-dash lines represent digital audio-visual connections.

FIG. 3 is a flow chart of a method in accordance with an embodiment of the invention.

### DETAILED DESCRIPTION

The present invention provides for a computer monitor with a built-in KVM switch. An action that would be used to switch source computers for some monitors, results in switching a keyboard and mouse as well. Variants of the invention switch other peripherals as well, such as speakers and various other peripherals, including printers, scanners, cameras (webcams), and external hard drives. This flexibility is achieved without adding a separate switch device.

In accordance with a “legacy” embodiment of the invention, a computer system AP1 includes a monitor 10, computers 11 and 12, a keyboard 13, and a mouse 15. Of course, computers 11 and 12 each have one or more processors for executing instructions and media for storing the instructions and data manipulated by the instructions. In addition, they have communications devices, including input output devices. These include respective VGA ports 17 and 19, respective PS2 keyboard ports 21 and 23, and respective PS2 mouse ports 25 and 27. As explained further below, the invention supports many connection standards other than VGA and PS2.

Monitor 10 includes a display panel 31, a surrounding bezel 33, and a base 35. Bezel 33 includes an on/off button 37 and a source button 39. Base 35 includes a KVM switch 40 controlled by source button 39. KVM switch has ten ports, a mouse port 41, a keyboard port 43, a display port 45, a control port 47, first computer keyboard, video, and mouse ports 49, 51, and 53, and second computer keyboard, video, and mouse ports 55, 57, and 59. Display port 45 and control port 47 are involved in connections internal to monitor 10. The remaining KVM ports have corresponding connectors on base 35. Thus, base 35 has keyboard and mouse PS2 connectors 61, and VGA connectors 63.

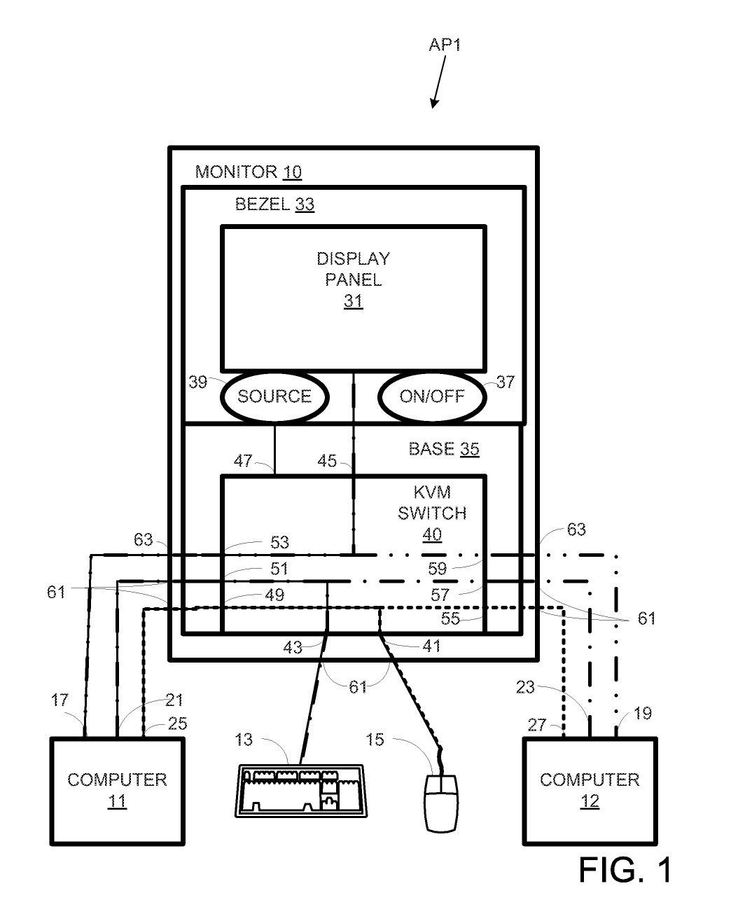

In the state represented in FIG. 1, the connections from monitor 10 to computer 11 are active (as indicated by the connected dot dashes), and the connections between monitor 10 and computer 12 are inactive (as indicated by the unconnected dots and dashes). In this state, the contents of display 31 are determined by computer 11 (and not computer 12), and the signals from keyboard 13 and mouse 15 are received by computer 11 (and not computer 12).

With KVM switch 40 in the illustrated state, pushing “source” button 39 toggles KVM switch so that the connections with computer 11 become active and the connections to computer 12 become inactive. In this state, computer 12 (and not computer 11) controls the contents of display 31; keyboard and mouse signals are received by computer 12 (and not computer 11). Of course, the physical connections external to monitor 10 are unchanged, but the electrical connectively has changed.

As noted above, there are many connection devices for computer peripherals. The invention provides for all of these. A monitor can provide for multiple video connection standards (VGA, DVI-D, DVD-I, DVI-A. DisplayPort and HDMI), and multiple other connection standards (PS2, USB, parallel, serial 232, ADB, and USB). Of course, different numbers of computers can be provided for, as well as different numbers and types of peripherals.

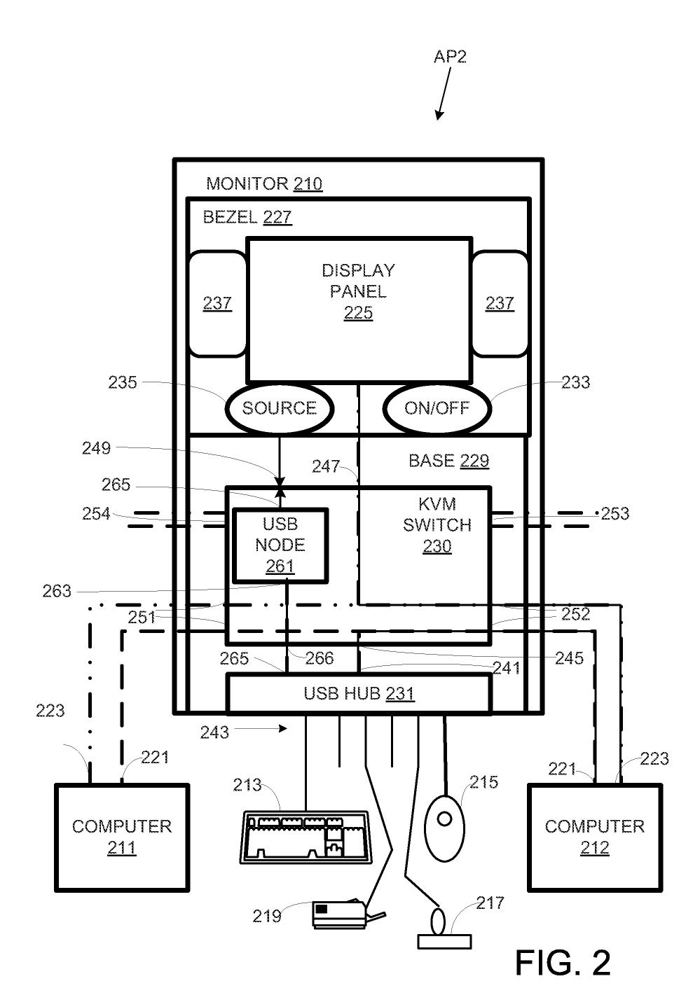

For example, a second computer system AP2 in accordance with a second “current” embodiment of the invention is shown in FIG. 2. Computer system AP2 includes a monitor 210, computers 211, and 212, a keyboard 213, a trackball 215, a joystick 217, and a printer 219. Computers 211 and 212 are similar to computers 11 and 12, but have at least one USB port 221 and one HDMI port 223 each.

Monitor 210 includes a display panel 225, a bezel 227, and a base 229. A KVM switch 230 and a USB hub 231 are built into base 229 and thus into monitor 210. An ON/OFF button 233 and a “source” selection button 235 are built into bezel 227. Speakers 237 are mounted behind a perforated portion of bezel 227.

USB hub 231 has one upstream port 241 and six downstream ports 243, represented by connectors on base 229. Four of the downstream ports are respectively coupled to keyboard 213, trackball 215, joystick 217, and printer 219. KVM switch 230 has an internal port 245 for the upstream USB signal, an internal AV port 247 for display panel 225 and speakers 237, and an internal control port 249 coupled to source button 235. KVM switch 230 also has four upstream-USB/HDMI pairs of connections 251, 252, 253, and 254, two of which are respectively coupled to computers 211 and 212, and the other two of which are shown unconnected in FIG. 2. Selection of the active pair of ports is effected by pushing source button 235, which cycles through port pairs 251-254 and back to 251, etc. Note that switch 230 qualifies as a KVM switch even though no mouse is actually connected, and that even if a mouse were connected, there would be no separate “M” connection, as the USB device signals are time multiplexed by USB hub 231.

KVM switch 230 includes a USB node 261, enabling it to send, receive, and interpret USB signals. USB node 261 includes a USB port 263, connected to a KVM port 266. This port is coupled internally with respect to monitor 210 to form an internal downstream connection between hub 231 and node 261. This allows monitor 210 to respond directly to commands from keyboard 213 and other USB input devices, rather than having to rely on computer interpretations of those commands. USB node 261 includes a command port 265 coupled to control port 249 of KVM switch 230 so that the USB input commands can be used to select a source port (251-254), and thus between computers 211 and 212 (computer 212 shown selected in FIG. 2). Thus, a keyboard or other USB input device can be used as an alternative to source button 235 (also connected to control port 249) for controlling source selection. Having KVM switch 230, and thus monitor 210, interpret input commands directly avoids the confusion that might occur if computers 211 and 212 would otherwise interpret keyboard or other commands differently.

The HDMI connections provide audio as well as video signals so that the audio source for speakers 237 switches when the video source switches. Monitor 210 can be connected to computers with DVI-D or DVD-I connections instead of an HDMI connection; in this case, an adapter is required and audio may not be available (unless an audio variant of DVI-D is used). Alternative embodiments switch separate analog audio connections; other embodiments can use USB audio to drive speakers built into a monitor. When only one connected computer is supplying a video signal, monitor 210 automatically selects it as the source.

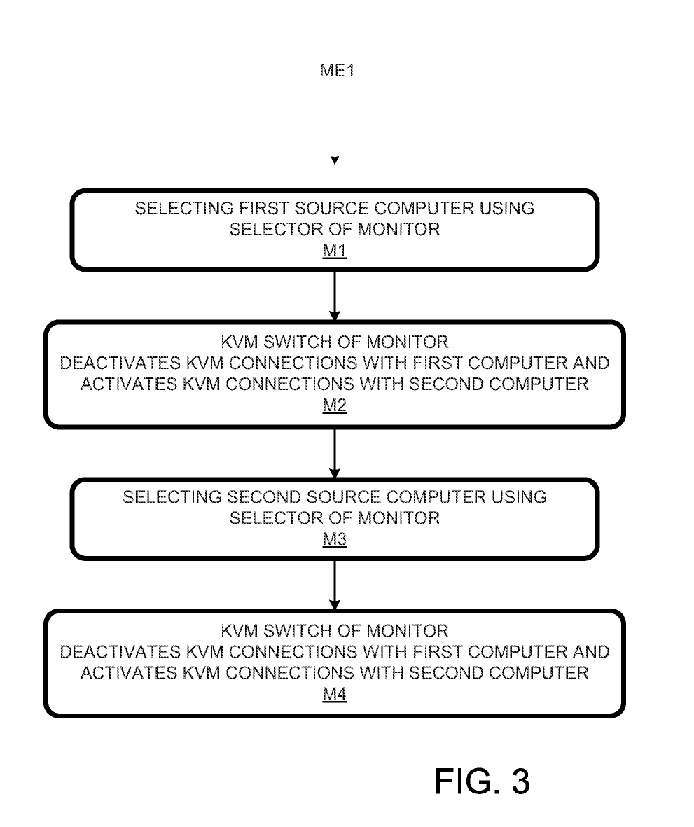

The invention provides for a method ME1 for sharing computer peripherals among plural computers, as flow-charted in FIG. 3. At method segment M1, a user selects a first computer using a selector on a monitor. In the illustrated embodiments, this is achieved by pushing a source button—which either toggles between two sources or cycles through three or more sources. At method segment M2, the monitor responds to the selection by activating KVM connections between the first computer and the monitor. At method segment M3, the user selects a second computer using the same or a different selector on the monitor. At method segment M4, the monitor response by inactivating the KVM connections to the first computer and activating KVM connections to a second computer.

Monitor 10 has VGA and PS2 connections. Monitor 210 has HDMI and USB connectors. Alternative embodiments provide for other video and input-device standards in addition to or instead of those represented by the illustrated embodiments. The attached computers can have connectors that correspond to those on the monitor or that can be accommodated using an adapter, for example, PS2-USB, DVI-HDMI, adapters. Additional device connectors such as additional USB connections can be provided and switched along with the video, keyboard and mouse. Also, more sets of ports can be provided so more computers can be accommodated. In addition, the invention provides for modes in which two host computers can be represented on a display at once, as in a picture-in-picture PIP mode. The invention also provides for combining video and input-device signals into a single cable as is done on some Apple computers.

Herein, a “KVM switch” is a switch that can concurrently switch keyboard, video, and mouse signals between host computers. Of course, a KVM switch is still a KVM switch whether or not devices are connected or whether or not the devices connected happen to include a keyboard, monitor and mouse. Some KVM switches can provide for switching devices other than keyboards, monitors, and mice. A keyboard switch can handle keyboard, monitor, and mouse signals in different channels using separate connectors or using a single cable with multiple channels. Alternatively, two or more of the keyboard, monitor, and mouse signals can be multiplexed in the same channel.

Source selecting can be effected using a single toggle switch (or button), or one that cycles through three or more sources. Alternatively, each device can have its own selector. If multiple sources are not accommodated, selecting one source can force deselection of others. These and other variations upon and modifications to the illustrated embodiment are provided for by the present invention, the scope of which is defined by the following claims.

What is claimed is:

1. A computer monitor comprising:
a display panel; and
a KVM switch coupled to said display panel for providing a video signal thereto, said KVM switch having inputs for receiving keyboard and mouse signals, said KVM switch having plural sets of ports, each of said sets providing for communication of keyboard, video, and mouse signals between said monitor and a respective computer.

2. A computer monitor as recited in claim 1 further comprising a USB hub with external downstream ports and an internal upstream port coupled to said KVM switch for controlling keyboard and mouse signals.

3. A computer monitor as recited in claim 2 wherein each of said sets includes a USB port for conveying said keyboard and said mouse signals.

4. A computer monitor as recited in claim 1 further comprising a selector for controlling said KVM switch so as to select which of plural computers is actively connected and which is not.

5. A computer monitor as recited in claim 4 wherein said selector is a button for toggling between or cycling among different sources to be actively connected to said monitor.

6. A computer monitor as recited in claim 1 further comprising inputs for a mouse and a keyboard.

7. A computer monitor as recited in claim 1 further comprising plural sets of ports, each set of ports being connectable via one or more cables to a respective computer, each set of ports including a video connector and connectors for keyboard and mouse signals.

8. A computer monitor as recited in claim 1 wherein said KVM switch also switches audio.

9. A computer monitor as recited in claim 1 further comprising a node for controlling said KVM switch so as to select among plural computers a computer to be actively connected to said monitor as a function of keyboard signals received by said node.

10. A computer monitor as recited in claim 1 further comprising a USB node for controlling said KVM switch so as to select among plural computers a computer to be actively connected to said monitor as a function of USB signals received by said node.

11. A method comprising:
selecting a first computer by controlling a source selector of a computer monitor; and
said monitor, in response to said selection of said first computer, activating connections between said first computer and said monitor to permit keyboard, video, and mouse signals to be communicated between said first computer and said monitor.

12. A method as recited in claim 11 wherein said controlling involves contacting said monitor.

13. A method as recited in claim 11 wherein said controlling involves contacting said keyboard or said mouse.

14. A method as recited in claim 11 further comprising:
while said connections to said first computer are active, operating said source selector to select a second computer; and
said monitor, in response to said selection of said second computer, deactivating said connections to said first computer and activating connections between said monitor and said second computer.

15. A method as recited in claim 11 wherein, in response to said selection of said second computer, inactivating a connection for carrying an audio signal from said first computer to said monitor and activating a connection for carrying an audio signal from said second computer to said monitor.

16. A method as recited in claim 11 wherein, said inactivating and activating involves switching an upstream USB signal from said first computer to said second computer.
